(19) United States
(12) Patent Application Publication
(10) Pub. No.: US 2026/0054299 A1
(43) Pub. Date: Feb. 26, 2026

(54) ENHANCED HOT WATER WASH FOR FIXED BED REACTORS

(71) Applicant: UOP LLC, Des Plaines, IL (US)

(72) Inventor: Jessy E. Trucko, Lake Forest, IL (US)

(21) Appl. No.: 19/208,817

(22) Filed: May 15, 2025

Related U.S. Application Data
(60) Provisional application No. 63/687,221, filed on Aug. 26, 2024.

(51) Int. Cl. B08B 9/08; B01J 27/04

(52) U.S. Cl. CPC B08B 9/0813; B01J 27/04; B08B 2230/01

(57) ABSTRACT

Processes for hot water washing a reactor which significantly reduce the amount of water used are described. The processes involve reducing the alkalinity of the reactor with warm water, then heating and recycling the water while adding a hot water wash reagent to clean the catalyst pores, restore catalytic activity, and hold the removed contaminants in the aqueous solution.

### RELATED APPLICATIONS

This application claims the benefit of U.S. Provisional Patent Application Ser. No. 63/687,221, filed on Aug. 26, 2024, the entirety of which is incorporated herein by reference.

### BACKGROUND

The Fixed Bed Merox™ process from UOP LLC is a catalytic chemical process for removing sulfur, such as mercaptans, from hydrocarbon streams, such as light naphthas, kerosene, and jet fuel by converting them to liquid hydrocarbon disulfides. Other fixed bed sulfur removal technologies are available from other sources, such as Mericat™ mercaptan removal solution from Merichem Technologies.

As the operating life of the catalyst bed increases, re-alkalinization or incremental caustic addition will become less and less effective in restoring the mercaptan oxidation catalyst conversion activity. More frequent caustic re-circulation or higher caustic addition will become necessary. Eventually, even re-alkalinization with fresh caustic from 1 to 20 weight percent NaOH (6.6 wt % preferred) will no longer be sufficient to restore the catalytic activity of the bed. At this point, the unit needs to be shut down to allow a hot water wash of the activated carbon supported catalyst, for example.

Hot water washing is effective in removing the impurities that collect in the activated carbon supported catalyst pores. These materials are commonly salts, such as species of sodium naphthenates and sodium cresolates, or other impurities such as pipeline chemicals, hydrocarbons heavier than jet fuel, and process additives injected upstream of the fixed bed reactor. The phenomenon of pore plugging and catalyst coating is typically gradual and will generally allow the need for future hot water washing to be anticipated and scheduled for a convenient time. However, incorrect operation of upstream unit operations, such as the crude column, over injection of additives, or caustic prewash, can lead to rapid deactivation requiring immediate action.

In typical prior art hot water washes, the water flows through the reactor and is sent to the water treatment facility. U.S. Pat. No. 4,213,877 describes a once through wash water process.

The hot water wash requires a significant amount of water, e.g., 8 gpm of water at 200° F. for every 100 cubic feet of catalyst. For a 10,000 barrel/day unit at 1 LHSV (2340 cu ft of catalyst), this rate is about 190 gpm. In some cases, hot water washes lasting 2 to 4 days or more have been required. This results in about 270,000 gallons of water per day that needs to be disposed of or treated in the water treatment plant.

There are increasing constraints on the amount of water used in industrial processes, as well as environmental concerns about the availability and quality of water. Additionally, each day of hot water washing results in a day of missed production of jet fuel, resulting in substantial costs in lost production.

Therefore, there is a need for a process of cleaning a fixed bed reactor which reduces the amount of water used in the process and the time required to complete the process.

### BRIEF DESCRIPTION OF THE DRAWINGS

FIG. 1 illustrates one embodiment of a prior art process for hot water washing of a fixed bed reactor.

FIG. 2 illustrates one embodiment of process for hot water washing of a fixed bed reactor according to the present invention.

### DESCRIPTION

The present invention meets that need by providing a novel hot water washing process which significantly reduces the amount of water used. The process involves reducing the alkalinity of the reactor with warm water, then heating and recycling the water while adding a hot water wash reagent to clean the catalyst pores, restore catalytic activity, and hold the removed contaminants in the aqueous solution.

High-quality “soft” water should be used for the hot water washing procedure. The water should have a total hardness of not more than 40 ppm as calcium carbonate. The wash water should contain a low concentration of bicarbonates of calcium, magnesium, and iron, etc. Otherwise, the insoluble carbonates formed via the well-known “water softening” reaction will deposit in the catalyst pores, resulting in reduced catalyst life.

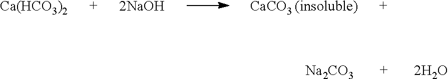

No free chlorine (e.g., less than 5 wppm, or less than 3 wppm, or less than 1 wppm, or less than 0.5 wppm, or less than 0.1 wppm, less than 0.05 wppm, or less than 0.01 wppm, or 0 wppm) can be tolerated in the water because any organic chlorine present, such as hypochlorite, will attack and decompose the catalyst impregnated on the support. For this reason, city water supplies cannot normally be used, even if they are “soft.” Suitable sources of high-quality “soft” water include, but are not limited to, clean steam condensate or boiler feedwater before any chemical additive injection, or combinations thereof.

The mercaptan oxidation catalyst comprises metal chelate mercaptan oxidation catalysts. Suitable metal chelate mercaptan oxidation catalysts are described in U.S. Pat. No. 4,213,877, for example. The mercaptan oxidation catalyst is also known as a sulfidic caustic oxidation catalyst.

The catalyst support can be any of the well-known solid adsorbent materials generally used as catalyst supports or carrier materials. It should have high surface area and stability in the presence of caustic. Suitable supports are described in U.S. Pat. No. 4,213,877, for example.

The hot water wash reagent may comprise alkyl-aryl ammonium chloride compounds. The alkyl-aryl ammonium chloride compound may comprises a quaternary ammonium compound represented by the structural formula:

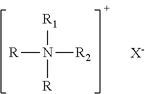

wherein R is a hydrocarbon radical containing up to about 20 carbon atoms and selected from the group consisting of alkyl, cycloalkyl, aryl, alkaryl and aralkyl;
R₁ is a substantially straight chain alkyl radical containing from about 5 to about 20 carbon atoms;
R₂ is selected from the group consisting of aryl, alkaryl and aralkyl; and
X is an anion.

Suitable anions include, but are not limited to, chloride, hydroxide, nitrate, nitrite, sulfate, phosphate, citrate, tartrate, and the like.

In some embodiments, sodium hydroxide, and cobalt phthalocyanine sulfate compounds are also included. The NaOH and cobalt phthalocyanine sulfate compounds ensure a slightly basic environment and protect the catalyst deposited on the high surface area support.

When the catalyst bed is to be hot water washed, the air injection is stopped, and the hydrocarbon flow is routed to an off specification storage area, isolating the reactor.

The hydrocarbon in the reactor is removed. Suitable methods of removing the hydrocarbon from the reactor include, but are not limited to, draining, pumping out, or pressuring the hydrocarbon out under steam pressure or nitrogen.

The reactor is filled with warm wash water (e.g., 10-65° C. (50-149° F.)) and drained, and the spent wash water is sent to the spent caustic facilities. This step should be repeated one or more times. It reduces the alkalinity of the wash water discharged to the sewer system significantly and protects the vessel from caustic attack. Typically, two rinses are enough to remove alkalinity for a reactor that is PWHT (post weld heat treatment); however, for older reactors that are not PHWT, the pH should be reduced to below 11 before continuing to the steam out step.

After the reactor has been drained and the major portion of residual caustic has been removed, steam is injected downflow, e.g., 4-6 lb/hr per cubic foot of catalyst bed (60-100 kg/hr per cubic meter activated carbon supported catalyst). The purpose of the steaming is to remove most of the remaining hydrocarbons from the catalyst and to heat the bed. Steaming should continue until a small steam plume appears at the reactor drain.

The reactor is filled with water at the typical rate for the particular reactor, then circulated from the bottom of the reactor to the top using the caustic circulation pump at 5% to 50% of the design feed rate, or 5% to 45%, or 5% to 40%, or 5% to 35%, or 5% to 30%, or 5% to 25%, or 5% to 20%, or 10% to 50%, or 10% to 45%, or 10% to 40%, or 10% to 35%, or 10% to 30%, or 10% to 25%, or 10% to 20%, or 15% to 50%, or 15% to 45%, or 15% to 40%, or 15% to 35%, or 15% to 30%, or 15% to 25%, or 15% to 20%.

Steam is introduced to the circulating water flow to heat the water and the reactor to a temperature in the range of 93-100° C. (200-212° F.).

As the hot water continues to circulate through the reactor, the hot water wash reagent is added to a concentration of 1 vol % to 20 vol %, or 1 vol % to 15 vol %, or 1 vol % to 10 vol %. Greater concentrations could be used; however, it does not increase the effectiveness, and it increases the cost. The reactor is operated so that it is substantially full. Therefore, water should be drained from the reactor at about the same volume as the hot water wash reagent and the second steam stream are entering the reactor. One way to ensure that the reactor remains substantially full is to adjust the drain rate so that there is a small flow out of the overhead vent line. Substantially full means that the water completely covers the catalyst bed, e.g., greater than 90% full, or greater than 95% full, or greater than 97% full, or greater than 98% full, or greater than 99% full.

The reactor effluent will be highly discolored (e.g., black, dark brown, and/or red) and foamy. After the water and hot water wash reagent have been added, circulation is continued for 0.5 to 24 hrs, or 1 to 20 hrs, or 2 to 20 hrs, 3 to 20 hrs, or 4 to 20 hrs, or 1 to 15 hrs, or 2 to 15 hrs, 3 to 15 hrs, or 4 to 15 hrs, 1 to 10 hrs, or 2 to 10 hrs, 3 to 10 hrs, or 4 to 10 hrs, or 1 to 6 hrs, or 2 to 6 hrs, 3 to 6 hrs, or 4 to 6 hrs, while maintaining the temperature. Longer circulation times could be used, but it is not necessary.

At this point, the water wash is essentially complete, and the bottom drain line is opened to empty the recirculating stream comprising the steam and the hot water wash reagent (if present), as well as the contaminants removed from the catalyst from the reactor.

The reactor is filled with cool water and the top vent line is closed when water overflows the reactor. Continue to add water to the reactor to cool the catalyst bed down to a temperature of about 60° C. (140° F.) or less and rinse the remaining hot water wash, hot water wash reagent, and impurities removed from the catalyst from the reactor. This temperature can be monitored by water drained from the drain line. Nitrogen can be used to maintain the reactor under a slight positive pressure. After the bed is cooled, the water is either drained by gravity or displaced with nitrogen pressure, and all of the water in the reactor is drained.

The reactor is then alkalized with caustic (e.g., 1-30 wt %, or 6 to 15 wt %), and the reactor can be restarted using the standard procedure.

Draining any of the streams (e.g., first, or second wash water streams or cool water stream) from the reactor can be by gravity and/or pressurized nitrogen can be introduced to the reactor to displace the water.

The process may generate 70,000 gallons of water compared to 270,000 to 1.1 million gallons in the prior art process discussed above. For a one day water wash, the reduction may be 75% to 83%, while it could be 96% for a four day water wash. Further reductions may be possible.

The process reduces the time the reactor is offline being cleaned and the revenue lost because the product is not being produced.

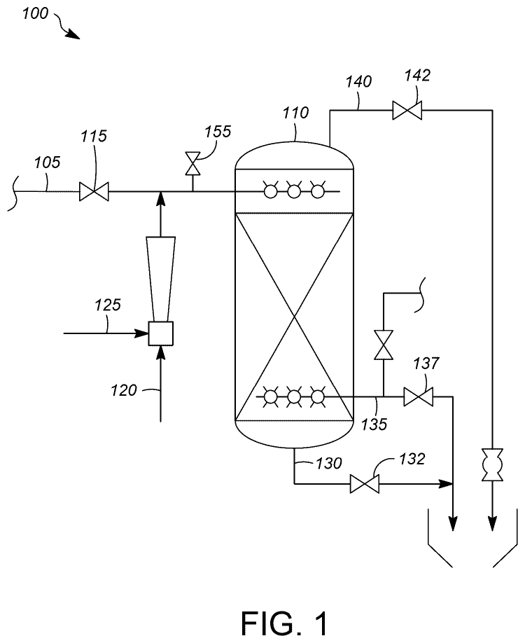

FIG. 1 is an illustration of a once through water washing process 100. Hydrocarbon feed stream 105 to reactor 110 is closed with valve 115 to stop the flow of hydrocarbons to the reactor 110. Gravity with valve 142 open, or nitrogen pressure with valve 142 closed, can be used to drain the hydrocarbon through effluent streams 130 and 135. When the reactor 110 is empty, valves 132 and 137 are closed, and valve 142 is opened. A first wash water stream 120 flows into the reactor 110 and fills the reactor 110 until water flows through the overhead stream 140 indicating the reactor 110 is water full. Valves 132 and 137 are then opened to drain the reactor 110, under gravity with valve 142 open, or with the assistance of nitrogen with valve 142 closed. The first wash water effluent stream, combined effluent streams 130 and 135 and optionally overhead stream 140, is sent to a water treatment facility.

The initial water wash may be repeated one or more times if desired. If it is determined that another wash is desired, valves 132 and 137 are closed again, and valve 142 is opened. A wash water stream 120 flows into the reactor 110 and fills the reactor 110 until water flows through the overhead stream 140 indicating the reactor 110 is full of water. Valves 132 and 137 are opened to drain the reactor 110, under gravity with valve 142 open, or with the assistance of nitrogen with valve 142 closed. The wash water effluent stream is sent to a water treatment facility.

Valve 142 is closed, and steam stream 125 flows through reactor 110 to raise its temperature and out through the effluent streams 130 and 135. When a plume of steam appears from effluent stream 130, the steam stream 125 is stopped, and the hot water wash begins.

A second wash water stream 120′ is combined with steam stream 125′ and sent to the reactor 110. Valves 132 and 137 are closed, and valve 142 is opened. The combined second wash water stream 120′ and steam stream 125′ flow into the reactor 110 and fills the reactor 110 until water flows through the overhead stream 140 indicating the reactor 110 is full of water. Valves 132 and 137 are opened to allow hot water to exit the reactor 110 while maintaining a small flow through overhead stream 140 to ensure the reactor 110 is full. Steam injection is adjusted to maintain a temperature over 200° F. in the effluent streams 130 and 135 which are sent to the water treatment facility. Any flow from the overhead stream 140 is sent to the water treatment facility. When the effluent streams 130 and 135 are essentially clear, this indicates the hot water wash is complete. Second wash water stream 120′ and steam stream 125′ are stopped, and valves 132 and 137 are opened to drain the reactor 110 under gravity with valve 142 open or with the assistance of nitrogen with valve 142 closed. The wash water effluent is sent to a water treatment facility. Valves 132 and 137 are closed.

A final water reactor quench stream 120″ flows into the reactor 110 and fills the reactor 110 until water flows through the overhead stream 140 indicating the reactor 110 is full of water. Valves 132 and 137 are then opened to drain the reactor 110 under gravity until the water temperature is less than 60° C. Water reactor quench stream 120″ is stopped, and valves 132 and 137 are opened to drain the reactor 110 under gravity with 142 open or with the assistance of nitrogen with 142 closed. The water quench effluent stream is sent to a water treatment facility.

A caustic stream (e.g., 1-30 wt %, or 6 to 15 wt %) may be introduced into the reactor 110 to increase the pH to 14 or greater. Nitrogen can be introduced through valve 155 to help drain the hydrocarbon feed stream 105, the first, or second wash water streams 120, 120′, 120″, or the reactor quench stream 120′″ from the reactor 110.

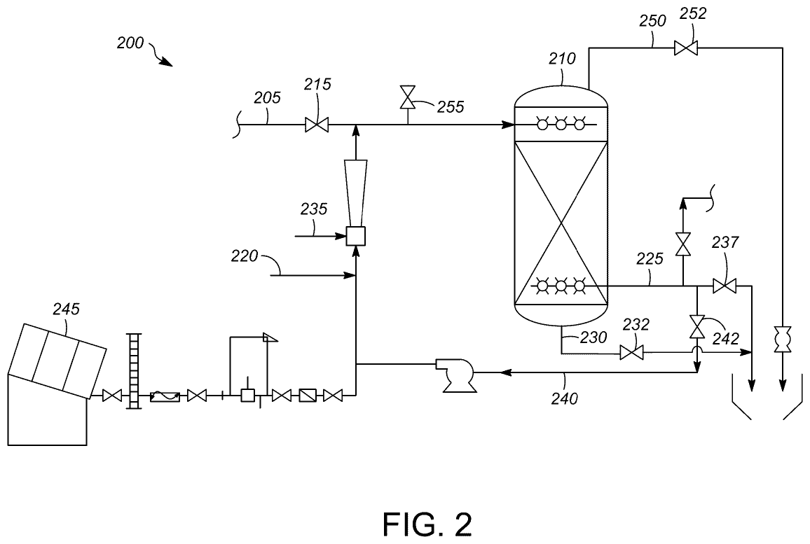

FIG. 2 illustrates one embodiment of the recirculating process 200 of the present invention.

Hydrocarbon feed stream 205 to reactor 210 is closed with valve 215 to stop the flow of hydrocarbons to the reactor 210. Gravity with valve 252 open or nitrogen pressure with valve 252 closed can be used to drain the hydrocarbon through streams 225 and 230. When the reactor 210 is empty, valves 232 and 237 are closed, and valve 252 is opened.

A first wash water stream 220 flows into the reactor 210 and fills the reactor 210 until water flows through the overhead stream 250 indicating the reactor 210 is full of water. Valves 232 and 237 are opened to drain the reactor 210 under gravity with valve 252 open or with the assistance of nitrogen with valve 252 closed. The first wash water effluent comprising streams 225 and 230 is sent to a water treatment facility.

The initial water wash may be repeated one or more times if desired, as described above.

Valve 252 is closed, and steam stream 235 flows through reactor 210 and out through effluent streams 230 and 225 to raise the reactor temperature and to remove volatile material. When a plume of steam appears from streams 230 and 225, steam stream 235 is stopped, and the enhanced hot water wash begins. This steam heating step is not required. However, when it is not included, the process uses more steam when the second steam stream is added to the recirculating third stream as described below. In addition, there is no removal of volatile material before the enhanced hot water wash begins.

Valves 232 and 237 are closed, and valve 252 is opened. Second wash water stream 220′ fills reactor 210 until flow is seen out of overhead stream 250. Recirculation is then established by opening valve 242, and recirculated water flows through the recirculation line 240 and back through the reactor 210. After circulation is established, and flow is verified out of overhead stream 250, the second wash water stream 220′ is stopped. This process uses significantly less water because the fresh water to the reactor is stopped, and the water is recirculated through the reactor.

The second steam stream 235′ is added to wash water recirculation stream and the combined stream flows through the reactor 210 and back through recirculation line 240 until the temperature is raised above 95° C. (200° F.). The second steam stream 235′ is stopped when the desired temperature is reached, which reduces steam usage. The second steam stream 235′ may be restarted as needed to raise the circulating stream 240 above 95° C. (200° F.).

During the recirculation of the second wash water stream 220′ and the second steam stream 235′ through recirculation line 240, a hot water wash reagent 245 is added to the recirculation line 240.

A small flow from the overhead stream 250 keeps the reactor 210 substantially full.

After the appropriate length of time (e.g., 0.5 hrs to 24 hrs), recirculation through recirculation line 240 is discontinued, valves 232 and 237 are opened, and the recirculated water is drained from the reactor 210. The reactor 210 can be drained under gravity with valve 252 open or with the assistance of nitrogen with valve 252 closed. The second wash water effluent comprising streams 225″ and 230″ is sent to a water treatment facility.

Valve 252 is opened while a final water reactor quench stream 220′″ is introduced into the reactor 210 to reduce the temperature of the reactor 210. Valves 232 and 237 are closed to fill the reactor with cool water until flow is observed through stream 250 indicating the reactor is substantially full. Valve 232 is then opened until the flow from stream 250 is reduced to a small flow ensuring the reactor is substantially full. Water is added to the reactor until the water from stream 230 is less than 60° C. (140° F.). The water reactor quench stream 220′″ is drained from the reactor 210 under gravity with valve 252 open or with the assistance of nitrogen with valve 252 closed. The second wash water effluent comprising streams 225′″ and 230′″ is sent to a water treatment facility.

A caustic stream (e.g., 1-30 wt %, or 6 to 15 wt %) is introduced into the reactor 210 to increase the pH to 14 or greater.

Nitrogen can be introduced through valve 255 to help drain the hydrocarbon feed stream 205, the first, or second wash water streams 220, 220′, 220″, or the cool water stream 220″″ from the reactor 210.

### Example

The following experimental hot water wash procedure was tested in a refinery.

The hydrocarbon feed to the reactor was stopped and routed to an off specification storage tank at 07:00, and the reactor was isolated. At 10:45, the reactor finished draining, and the hydrocarbon was pumped out from the reactor.

At 11:00, the reactor was filled and drained with warm wash water until the pH was less than 12.4.

At 13:45, water circulation and heating was started and continued until 100° C. was achieved. Circulation of the hot water wash was continued.

The temperature was maintained overnight with the reactor on hold to continue the test on day 2.

At 08:15 on the second day, the hot water injection was stopped, and the addition of 220 gallons of hot water wash reagent was started. There was 1912 ft³ of catalyst, and about 17,000 gallons of water in the reactor, piping, and loop.

At 11:00, the addition of the hot water wash reagent was stopped.

The hot water wash reagent/water circulation was stopped at 13:00, and the reactor was drained under nitrogen pressure.

At 13:50 brought in 8.5 weight % Caustic to fill the reactor and alkalinize the reactor catalyst bed.

At 18:00, all blinds were removed and the unit was started up using the normal procedure.

Prior to the water wash procedure, the unit was operating at 50% feed rate and producing 40 wppm RSH-S product. When the unit was restarted after the hot water wash procedure, the feed rate was 100% of design flow rate, and the reactor produced a product that was on specification at 11 to 16 wppm RSH-S.

### Specific Embodiments

While the following is described in conjunction with specific embodiments, it will be understood that this description is intended to illustrate and not limit the scope of the preceding description and the appended claims.

A first embodiment of the invention is a process for reducing water consumption in a water wash of a reactor comprising introducing a first wash water stream to a reactor comprising a mercaptan oxidation catalyst that has been deactivated to reduce the alkalinity of the mercaptan oxidation catalyst and draining the first wash water stream from the reactor; optionally injecting a steam stream to remove hydrocarbons from the mercaptan oxidation catalyst and to heat the bed; filling the reactor with a second wash water stream after injecting the optional steam stream and recirculating the second water wash stream through the reactor so that the reactor remains substantially full; introducing a second steam stream into the second water wash stream while recirculating the second wash water stream to raise the reactor to a temperature to a range of 93-100° C.; discontinuing the recirculation of the second wash water stream after a time of 0.5 to 24 hours; and draining the second wash water stream from the reactor. An embodiment of the invention is one, any or all of prior embodiments in this paragraph up through the first embodiment in this paragraph further comprising adding a hot water wash reagent comprising an alkyl-aryl ammonium chloride compound to the reactor while recirculating the second wash water stream. An embodiment of the invention is one, any or all of prior embodiments in this paragraph up through the first embodiment in this paragraph wherein the alkyl-aryl ammonium chloride compound comprises a quaternary ammonium compound represented by the structural formula

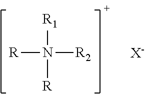

wherein R is a hydrocarbon radical containing up to about 20 carbon atoms and selected from the group consisting of alkyl, cycloalkyl, aryl, alkaryl and aralkyl; R₁ is a substantially straight chain alkyl radical containing from about 5 to about 20 carbon atoms; R₂ is selected from the group consisting of aryl, alkaryl and aralkyl; and X is an anion. An embodiment of the invention is one, any or all of prior embodiments in this paragraph up through the first embodiment in this paragraph wherein the hot water wash reagent further comprises sodium hydroxide, or cobalt phthalocyanine sulfate compounds, or both. An embodiment of the invention is one, any or all of prior embodiments in this paragraph up through the first embodiment in this paragraph further comprising discontinuing the second steam stream and introducing a cool water stream into the reactor after draining the second wash water stream from the reactor to reduce a temperature of the reactor to a temperature of less than or equal to 60° C. (140° F.). An embodiment of the invention is one, any or all of prior embodiments in this paragraph up through the first embodiment in this paragraph further comprising draining the cool water stream from the reactor. An embodiment of the invention is one, any or all of prior embodiments in this paragraph up through the first embodiment in this paragraph wherein draining the cool water stream from the reactor comprises introducing nitrogen into the reactor to displace the cool water stream. An embodiment of the invention is one, any or all of prior embodiments in this paragraph up through the first embodiment in this paragraph further comprising introducing a caustic stream into the reactor to increase a pH to greater than 14 after draining the cool water stream from the reactor. An embodiment of the invention is one, any or all of prior embodiments in this paragraph up through the first embodiment in this paragraph wherein the first wash water stream has a temperature in a range of 10 to 60° C. An embodiment of the invention is one, any or all of prior embodiments in this paragraph up through the first embodiment in this paragraph further comprising introducing nitrogen into the reactor to drain the first wash water stream, or the second wash water stream, or combinations thereof. An embodiment of the invention is one, any or all of prior embodiments in this paragraph up through the first embodiment in this paragraph further comprising draining a hydrocarbon stream from the reactor before introducing the first wash water stream to the reactor. An embodiment of the invention is one, any or all of prior embodiments in this paragraph up through the first embodiment in this paragraph wherein the second wash water stream is recirculated for 4 to 6 hrs. An embodiment of the invention is one, any or all of prior embodiments in this paragraph up through the first embodiment in this paragraph further comprising treating the drained first wash water stream in a water treatment facility.

A second embodiment of the invention is a process for reducing water consumption in a water wash of a reactor comprising introducing a first wash water stream to a reactor comprising a mercaptan oxidation catalyst that has been deactivated to reduce the alkalinity of the mercaptan oxidation catalyst and draining the first wash water stream from the reactor; optionally injecting a steam stream to remove hydrocarbons from the mercaptan oxidation catalyst and to heat the bed; filling the reactor with a second wash water stream after injecting the optional steam stream and recirculating the second wash water stream through the reactor so that the reactor remains substantially full; adding a hot water wash reagent comprising an alkyl-aryl ammonium chloride compound to the reactor while recirculating the second wash water stream; introducing a second steam stream into the second wash water stream to raise the reactor to a temperature in a range of 93-100° C.; discontinuing the recirculation of the second wash water stream after a time of 0.5 to 24 hours; draining the second wash water stream from the reactor; discontinuing the second steam stream and introducing a cool water stream into the reactor after draining the second wash water stream from the reactor to reduce the temperature of the reactor to a temperature of less than or equal to 60° C. (140° F.); draining the cool water stream from the reactor; and introducing a caustic stream into the reactor to increase a pH to greater than 14 after draining the cool water stream from the reactor. An embodiment of the invention is one, any or all of prior embodiments in this paragraph up through the second embodiment in this paragraph wherein the alkyl-aryl ammonium chloride compound comprises a quaternary ammonium compound represented by the structural formula

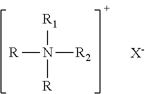

wherein R is a hydrocarbon radical containing up to about 20 carbon atoms and selected from the group consisting of alkyl, cycloalkyl, aryl, alkaryl and aralkyl; R₁ is a substantially straight chain alkyl radical containing from about 5 to about 20 carbon atoms; R₂ is selected from the group consisting of aryl, alkaryl and aralkyl; and X is an anion. An embodiment of the invention is one, any or all of prior embodiments in this paragraph up through the second embodiment in this paragraph wherein the hot water wash reagent further comprises sodium hydroxide, or cobalt phthalocyanine sulfate compounds, or both. An embodiment of the invention is one, any or all of prior embodiments in this paragraph up through the second embodiment in this paragraph wherein the first wash water stream has a temperature in a range of 10 to 60° C. An embodiment of the invention is one, any or all of prior embodiments in this paragraph up through the second embodiment in this paragraph further comprising introducing nitrogen into the reactor to drain the first wash water stream, or the second wash water stream, or combinations thereof. An embodiment of the invention is one, any or all of prior embodiments in this paragraph up through the second embodiment in this paragraph wherein the second wash water stream is recirculated for 4 to 6 hrs. An embodiment of the invention is one, any or all of prior embodiments in this paragraph up through the second embodiment in this paragraph further comprising treating the drained first wash water stream in a water treatment facility.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A process for reducing water consumption in a water wash of a reactor comprising:
introducing a first wash water stream to a reactor comprising a mercaptan oxidation catalyst that has been deactivated to reduce the alkalinity of the mercaptan oxidation catalyst and draining the first wash water stream from the reactor;
optionally injecting a steam stream to remove hydrocarbons from the mercaptan oxidation catalyst and to heat the bed;
filling the reactor with a second wash water stream after injecting the optional steam stream and recirculating the second wash water stream through the reactor so that the reactor remains substantially full;
introducing a second steam stream into the second wash water stream while recirculating the second wash water stream to raise the reactor to a temperature in a range of 93-100° C.;
discontinuing the recirculation of the second wash water stream after a time of 0.5 to 24 hours; and
draining the second wash water stream from the reactor.

2. The process of claim 1 further comprising:
adding a hot water wash reagent comprising an alkyl-aryl ammonium chloride compound to the reactor while recirculating the second wash water stream.

3. The process of claim 2 wherein the alkyl-aryl ammonium chloride compound comprises:
a quaternary ammonium compound represented by the structural formula 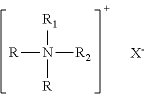
wherein R is a hydrocarbon radical containing up to about 20 carbon atoms and selected from the group consisting of alkyl, cycloalkyl, aryl, alkaryl and aralkyl;
R₁ is a substantially straight chain alkyl radical containing from about 5 to about 20 carbon atoms;
R₂ is selected from the group consisting of aryl, alkaryl and aralkyl; and
X is an anion.

4. The process of claim 2 wherein the hot water wash reagent further comprises sodium hydroxide, or cobalt phthalocyanine sulfate compounds, or both.

5. The process of claim 1 further comprising:
discontinuing the second steam stream and introducing a cool water stream into the reactor after draining the second wash water stream from the reactor to reduce the temperature of the reactor to a temperature of less than or equal to 60° C. (140° F.).

6. The process of claim 5 further comprising:
draining the cool water stream from the reactor.

7. The process of claim 6 wherein draining the cool water stream from the reactor comprises introducing nitrogen into the reactor to displace the cool water stream.

8. The process of claim 6 further comprising:
introducing a caustic stream into the reactor to increase a pH to greater than 14 after draining the cool water stream from the reactor.

9. The process of claim 1 wherein the first wash water stream has a temperature in a range of 10 to 60° C.

10. The process of claim 1 further comprising:
introducing nitrogen into the reactor to drain the first wash water stream, or the second wash water stream, or combinations thereof.

11. The process of claim 1 further comprising:
draining a hydrocarbon stream from the reactor before introducing the first wash water stream to the reactor.

12. The process of claim 1 wherein the second wash water stream is recirculated for 4 to 6 hrs.

13. The process of claim 1 further comprising:
treating the drained first water wash stream in a water treatment facility.

14. A process for reducing water consumption in a water wash of a reactor comprising:
introducing a first wash water stream to a reactor comprising a mercaptan oxidation catalyst that has been deactivated to reduce the alkalinity of the mercaptan oxidation catalyst and draining the first wash water stream from the reactor;
optionally injecting a steam stream to remove hydrocarbons from the mercaptan oxidation catalyst and to heat the bed;
filling the reactor with a second wash water stream after injecting the optional steam stream and recirculating the second water wash stream through the reactor so that the reactor remains substantially full;
adding a hot water wash reagent comprising an alkyl-aryl ammonium chloride compound to the reactor while recirculating the second wash water stream;
introducing a second steam stream into the second water wash stream to raise the reactor to a temperature in a range of 93-100° C.;
discontinuing the recirculation of the second wash water stream after a time of 0.5 to 24 hours;
draining the second wash water stream from the reactor;
discontinuing the second steam stream and introducing a cool water stream into the reactor after draining the second wash water stream from the reactor to reduce the temperature of the reactor to a temperature of less than or equal to 60° C. (140° F.);
draining the cool water stream from the reactor; and
introducing a caustic stream into the reactor to increase a pH to greater than 14 after draining the cool water stream from the reactor.

15. The process of claim 14 wherein the alkyl-aryl ammonium chloride compound comprises:
a quaternary ammonium compound represented by the structural formula 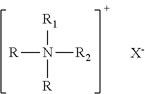
wherein R is a hydrocarbon radical containing up to about 20 carbon atoms and selected from the group consisting of alkyl, cycloalkyl, aryl, alkaryl and aralkyl;
R₁ is a substantially straight chain alkyl radical containing from about 5 to about 20 carbon atoms;
R₂ is selected from the group consisting of aryl, alkaryl and aralkyl; and
X is an anion.

16. The process of claim 14 wherein the hot water wash reagent further comprises sodium hydroxide, or cobalt phthalocyanine sulfate compounds, or both.

17. The process of claim 14 wherein the first wash water stream has a temperature in a range of 10 to 60° C.

18. The process of claim 14 further comprising:
introducing nitrogen into the reactor to drain the first wash water stream, or the second wash water stream, or combinations thereof.

19. The process of claim 14 wherein the second wash water stream is recirculated for 4 to 6 hrs.

20. The process of claim 14 further comprising:
treating the drained first wash water stream in a water treatment facility.
